(19) United States
(12) Patent Application Publication
(10) Pub. No.: US 2022/0288763 A1
(43) Pub. Date: Sep. 15, 2022

(54) MULTI-PIECE HOUSING FOR INDEXABLE MOTORIZED RATCHET TOOLS

(71) Applicant: Snap-on Incorporated, Kenosha, WI (US)

(72) Inventor: Joshua M. Beer, Kenosha, WI (US)

(73) Assignee: Snap-on Incorporated, Kenosha, WI (US)

(21) Appl. No.: 17/196,191

(22) Filed: Mar. 9, 2021

(51) Int. Cl. B25F 5/02; B25B 21/00; B25B 23/00

(52) U.S. Cl. CPC B25F 5/02; B25B 21/004; B25B 23/0028

(57) ABSTRACT

A tool housing for a tool, such as a motorized ratcheting-type tool. The tool housing includes a ratchet housing portion, a first housing portion pivotably coupled to the ratchet housing portion, a second housing portion having first and second opposing ends, and a motor housing portion coupled to the second end of the second housing portion. The first end of the second housing portion is threadably coupled to the first housing portion.

### TECHNICAL FIELD OF THE INVENTION

The present invention relates generally to housings for hand tools, and more particularly, the present invention relates to a multi-piece housing for indexable ratchet tools.

### BACKGROUND OF THE INVENTION

Power hand tools, such as, for example, motorized ratchet wrenches and drivers, are commonly used in automotive, industrial, and household applications to install and remove threaded fasteners and apply torque and/or angular displacement to a work piece, such as a threaded fastener, for example. Power hand tools such as cordless power ratchets and drivers generally include an electric motor contained in a housing, along with other components, such as switches, light emitting diodes (LEDs), and batteries, for example. The housing may be a clamshell type housing that generally includes two or more housing portions coupled together by fasteners such as screws or rivets to cooperatively form the housing.

Power hand tools, such as, for example, motorized ratchet wrenches and drivers, include a ratcheting-type head that is driven by a motor. However, the head is generally fixed relative to the tool body due to the necessity to place the motor in the housing. The fixed nature of the head can make it difficult to reach fasteners and other work pieces located in tight or otherwise hart to access places. Moreover, as the housing of the tool becomes longer, it becomes more difficult to manufacture and machine, thereby requiring specialty tools to complete the machining operation. Additionally, creating housings with various lengths is expensive, as this requires having multiple molds for the castings.

### SUMMARY OF THE INVENTION

The present invention relates broadly to a multi-piece housing for indexable ratchet tools, such as, for example, a motorized ratcheting-type tool. The housing includes a ratchet housing portion, a first housing portion, a second housing portion, and a motor housing portion. The first housing portion is pivotably coupled to the ratchet housing portion to allow an output mechanism of the tool, such as a drive lug, to be disposed at an angle relative to the motor housing portion of the tool, which houses a motor and other components. The second housing portion is threadably coupled to the first housing portion and coupled to the motor housing portion. The second housing portion can be made in varying lengths, thereby allowing many different lengths to be made using the same first housing and ratchet housing portions. The first housing portion includes external threads to minimize the size of the housing compared to housings with internal threads. This also allows the first housing portion to be relatively thin and minimize its weight, and the second housing portion to be relatively thick to increase strength and durability. Moreover, if the second housing portion is machined, it is less expensive to change the lengths because different molds of the first housing and ratchet housing portions do not have to be made or used.

In an embodiment, the present invention broadly relates to a tool. The tool broadly comprises a ratchet housing portion, a first housing portion pivotably coupled to the ratchet housing portion, and a second housing portion having first and second opposing ends. The first end of the second housing portion is threadably coupled to the first housing portion.

In another embodiment, the present invention broadly relates to a tool housing for a tool. The tool housing broadly comprises a ratchet housing portion, a first housing portion pivotably coupled to the ratchet housing portion, a second housing portion having first and second opposing ends, and a motor housing portion coupled to the second end of the second housing portion. The first end of the second housing portion is threadably coupled to the first housing portion.

### BRIEF DESCRIPTION OF THE DRAWINGS

For the purpose of facilitating an understanding of the subject matter sought to be protected, there is illustrated in the accompanying drawing embodiments thereof, from an inspection of which, when considered in connection with the following description, the subject matter sought to be protected, its construction and operation, and many of its advantages, should be readily understood and appreciated.

FIG. 1 is a perspective side view of an exemplar ratcheting tool, according to an embodiment of the present invention.

FIG. 2 is a side perspective view of a ratchet, and first and second housing portions of the ratcheting tool of FIG. 1, according to an embodiment of the present invention.

FIG. 3 is a side perspective exploded, disassembled view of the ratchet and first and second housing portions of the ratcheting tool of FIG. 1, according to an embodiment of the present invention.

FIG. 4 is a side perspective view of the ratchet housing pivoted relative to the first and second housing portions of the ratcheting tool of FIG. 1, according to an embodiment of the present invention.

### DETAILED DESCRIPTION

While the present invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated. As used herein, the term “present invention” is not intended to limit the scope of the claimed invention and is instead a term used to discuss exemplary embodiments of the invention for explanatory purposes only.

The present invention relates broadly to a multi-piece housing for indexable ratchet tools, such as a motorized ratcheting-type tool. The housing includes a ratchet housing portion, a first housing portion, a second housing portion, and a motor housing portion. The first housing portion is pivotably coupled to the ratchet housing portion to allow an output mechanism of the tool, such as, for example, a drive lug, to be disposed at an angle relative to the motor housing portion of the tool, which houses a motor and other components. It will be appreciated that other types output mechanisms can be used with the present invention, such as, for example, drill bits, screw bits, etc. The second housing portion is threadably coupled to the first housing portion at a first end and coupled to the motor housing portion at a second end.

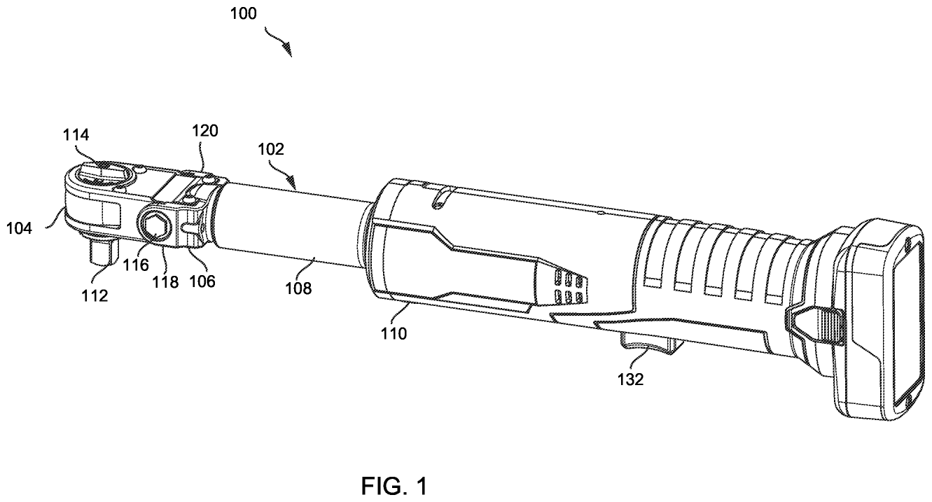

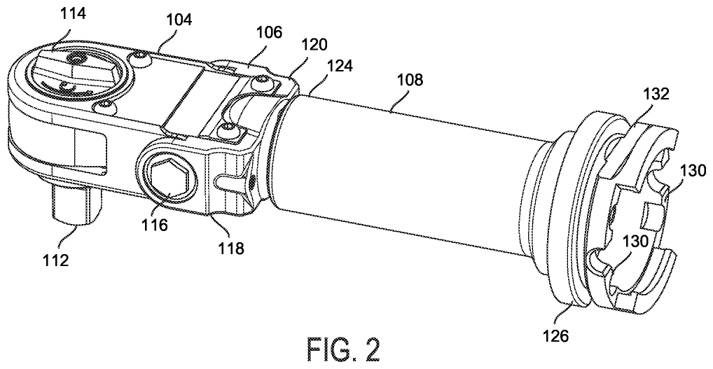

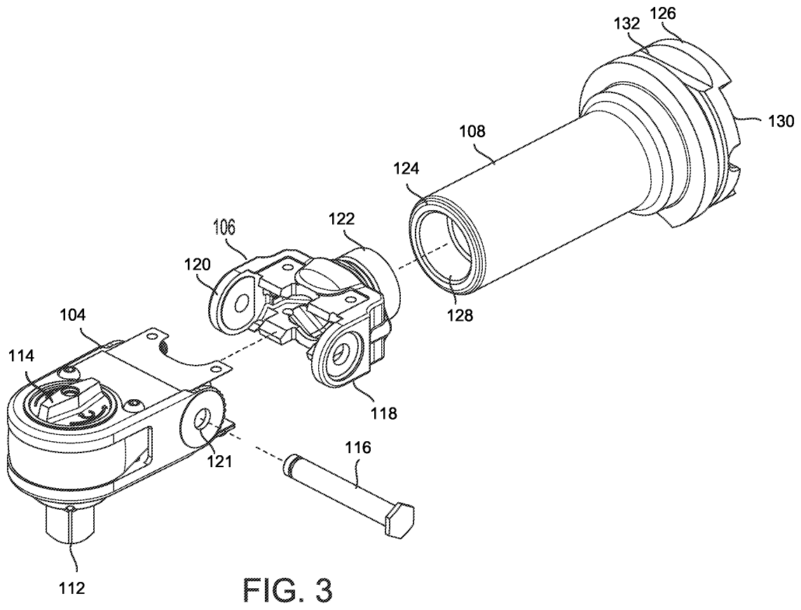

Referring to FIGS. 1-4, a tool 100, such as a cordless ratchet-type tool, includes a tool housing 102 having a ratchet housing portion 104, a first housing portion 106, a second housing portion 108, and a motor housing portion 110. As discussed herein, the tool 100 is a ratchet-type wrench. However, the present invention is not limited as such and the tool 100 can be any type of hand-held tool, including, without limitation, electrically or pneumatically powered tools, such as, a drill, router, impact wrench, ratchet wrench, screwdriver, or other powered tool.

The ratchet housing portion 104 encloses/houses a ratchet mechanism (not shown) that transfers torque from a motor of the tool 100 to a drive lug 112 in a well-known manner. The drive lug 112 is adapted to apply torque to a work piece, such as a fastener, via an adapter, bit, or socket coupled to the drive lug 112, such as a bi-directional ratcheting square or hexagonal drive. As illustrated, the drive lug 112 is a “male” connector designed to fit into or matingly engage a female counterpart. However, the drive lug 112 may alternatively include a “female” connector designed to matingly engage a male counterpart. The drive lug 112 may also be structured to directly engage a work piece without requiring coupling to an adapter, bit, or socket. The rotational direction of the drive lug 112 can be selected by rotation of a selector switch 114 to be either a first or second rotational direction (such as, clockwise or counterclockwise) in a well-known manner.

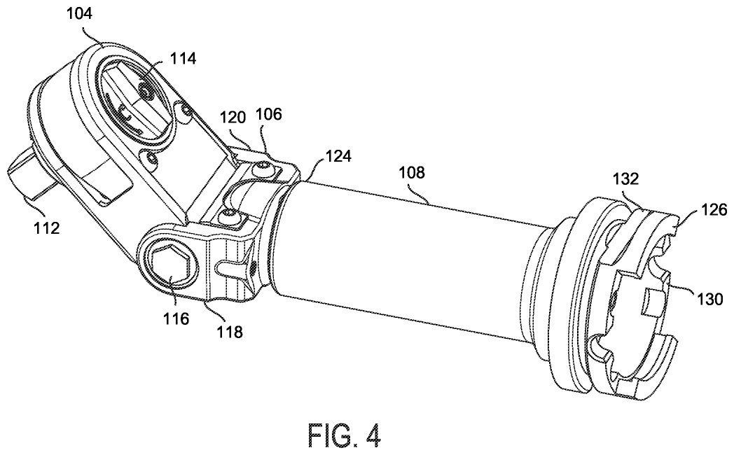

The ratchet housing portion 104 and the first housing portion 106 are adapted to pivotably couple to each other, for example, via a pivot pin 116. The pivot pin 116 may be a pin, rivet, threaded fastener, or other suitable fasteners that provide a pivotable coupling between the ratchet housing portion 104 and the first housing portion 106. The pivotable coupling allows for the ratchet housing portion 104 to pivot relative to the first housing portion 106. As illustrated in FIG. 4, the pivotable coupling allows the ratchet housing portion 104 to pivot relative to a longitudinal axis of the pivot pin 116, which is substantially perpendicular to a longitudinal axis of the tool 100, thereby allowing the ratchet housing portion 104 to pivot relative to the first housing portion 106, the second housing portion 108, and the motor housing portion 110.

The first housing portion 106 includes first 118 and second 120 yoke arms adapted to respectively receive the pivot pin 116, and the ratchet housing portion 104 includes an aperture 121 adapted to receive the pivot pin 116, thereby pivotably coupling the ratchet housing portion 104 and the first housing portion 106. The first housing portion 106 also includes an extension 122 having external threads. External threads minimize the size of the first housing portion 106 for increased access and lower weight compared to current solutions with internal threads. In an embodiment, the first housing portion 106 is a casting.

The second housing portion 108 encloses/houses a crankshaft (not shown) adapted to operably couple the ratchet mechanism to the motor in a well-known manner. The second housing portion 108 includes first 124 and second 126 opposing ends. The first end 124 includes an opening 128 adapted to receive and threadably couple to the extension 122. The opening 128 includes internal threads corresponding to external threads of the extension 122. In an embodiment, an adhesive or epoxy is used to restrict the extension 124 from being separated from the opening 124. The second end 126 is adapted to couple to the motor housing 110 using attachment features including, for example, cutouts 130 and/or channels 132. In an embodiment, the attachment features are machined in the second housing portion 108 after the second housing portion 108 is threadably coupled to the first housing portion 106 to ensure the ratchet housing portion 104 is properly oriented relative to the motor housing portion 110. In an embodiment, the second housing portion 108 is one of a number of interchangeable second housing portions having different lengths and/or configurations to accommodate crankshafts having different lengths. In an embodiment, the second housing portion 108 is a machined part, thereby allowing different lengths and configurations to be made at lower costs and complexity, compared to a cast part since multiple molds do not have to be made or used. In an embodiment, the first 104 and second 106 housings are combined as one integral housing.

The motor housing portion 110 encloses or houses one or more of an electric or pneumatic motor, a switch assembly, display with buttons for configuring and setting the tool, one or more status indicators such as light emitting diodes, and other components for operation of the tool, for example. The motor housing portion 110 may also include a textured or knurled grip to improve a user's grasp of the tool 100 during use. In an embodiment, the motor housing portion 110 includes first and second motor housing portions coupled together in a clamshell-type manner. In an embodiment, the motor housing portion 110 is a plastic part.

The motor (not shown) is adapted to operably engage the ratchet mechanism via the crankshaft to provide torque to the drive lug 112 in a well-known manner. In an embodiment, the motor may be a brushless or brushed-type electric motor, a pneumatic motor, or any other suitable motor. A power source (not shown) can be associated with the tool 100 to provide power to the tool 100 for operation, such as, for example, electric, hydraulic, or pneumatic, to operate the motor. In an embodiment, the power source can be housed in an end of the motor housing portion 110, opposite the ratchet housing portion 104, a midsection of the motor housing portion 110, or any other portion of the tool 100/motor housing portion 110. The power source may also be an external component not housed by the tool 100, but that is operatively coupled to the tool 100 through, for example, wired or wireless means. In an embodiment, the power source is a removable and rechargeable battery that is adapted to be disposed in the end of the motor housing portion 110 and electrically coupled to corresponding terminals of the tool 100 in a well-known manner.

In an embodiment, the tool 100 includes a trigger 132 that can be actuated by a user to cause the tool 100 to operate. For example, the user can depress the trigger 132 inwardly to selectively cause power to be drawn from the power source and cause the motor to provide torque to the drive lug 112 in a desired rotational direction. Any suitable trigger 132 or switch can be implemented without departing from the spirit and scope of the present invention. For example, the trigger 132 may also be biased such that the trigger 132 is inwardly depressible, relative to the tool 100, to cause the tool 100 to operate, and a release of the trigger 132 causes the trigger 132 to move outwardly, relative to the tool 100, to cease operation of the tool 100 via the biased nature of the trigger 132. The trigger 132 and switch mechanism may also be a variable speed type mechanism. In this regard, actuation or depression of the trigger 132 causes the motor to operate at a faster speed the further the trigger 132 is depressed.

The present invention allows the ratchet housing portion 104 and first housing portion 106 to be used with a number of different second housing portions 108 having different lengths and configurations. Thus, different casts and/or tooling for manufacturing of the ratchet housing portion 104 and first housing portion 106 are not needed to accommodate additional products with different lengths and configurations, thereby lowering the costs and complexity of manufacturing, compared to current solutions. Additionally, the present invention allows a relatively thin first housing portion 106 for lower weight, and a relatively thick second housing portion 108 for strength and durability.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object. As used herein, the term “a” or “one” may include one or more items unless specifically stated otherwise.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A tool comprising:
a ratchet housing portion;
a first housing portion pivotably coupled to the ratchet housing portion; and
a second housing portion having first and second opposing ends, wherein the first end is threadably coupled to the first housing portion.

2. The tool of claim 1, wherein the first housing portion includes first and second arms and the ratchet housing portion includes an aperture adapted to receive a pivot pin to pivotably couple the first housing portion to the ratchet housing portion.

3. The tool of claim 1, wherein the first housing portion includes an extension.

4. The tool of claim 3, wherein the second housing portion includes an opening disposed at the first end, and wherein the extension is threadably coupled to the opening.

5. The tool of claim 1, further comprising a motor housing portion, wherein the second housing portion includes one or more of cutouts and grooves disposed at the second end and coupled to the motor housing portion.

6. The tool of claim 5, wherein the motor housing portion includes a grip.

7. The tool of claim 5, wherein the cutouts and grooves are machined in the second housing portion after the second housing portion is threadably coupled to the first housing portion.

8. The tool of claim 5, wherein the motor housing portion includes first and second motor housing portions coupled together in a clamshell type manner.

9. The tool of claim 1, wherein the second housing portion is one of a number of second housing portions.

10. A tool housing for a tool, comprising:
a ratchet housing portion;
a first housing portion pivotably coupled to the ratchet housing portion; and
a second housing portion having first and second opposing ends, wherein the first end is threadably coupled to the first housing portion.

11. The tool housing of claim 10, further comprising a motor housing portion coupled to the second end of the second housing portion.

12. The tool housing of claim 11, wherein the motor housing portion includes first and second motor housing portions coupled together in a clamshell type manner.

13. The tool housing of claim 11, wherein the second end of the second housing portion includes one or more of cutouts and grooves that couple to the motor housing portion.

14. The tool of claim 12, wherein the cutouts and grooves are machined in the second housing portion after the second housing portion is threadably coupled to the first housing portion.

15. The tool housing of claim 10, wherein the first housing portion includes first and second arms and the ratchet housing portion includes an aperture adapted to receive a pivot pin to pivotably couple the first housing portion to the ratchet housing portion.

16. The tool housing of claim 10, wherein the first housing portion includes an extension and the second housing portion includes an opening disposed at the first end, wherein the extension is threadably coupled to the opening.

17. The tool housing of claim 10, wherein the second housing portion is any one of a number of interchangeable second housing portions.
